(19) United States
(12) Patent Application Publication
(10) Pub. No.: US 2018/0242375 A1
(43) Pub. Date: Aug. 23, 2018

(54) SYSTEM AND METHOD TO PERFORM SAFETY OPERATIONS IN ASSOCIATION WITH A NETWORK SERVICE

(71) Applicant: Uber Technologies, Inc., San Francisco, CA (US)

(72) Inventors: Michael O'Herlihy, San Francisco, CA (US); Kimberly Siegel, Los Angeles, CA (US)

(21) Appl. No.: 15/436,575

(22) Filed: Feb. 17, 2017

(51) Int. Cl. H04W 76/00; G06F 17/30; H04L 29/08; H04R 29/00

(52) U.S. Cl. CPC H04W 76/007; G06F 17/30312; H04R 29/00; H04L 67/18; H04L 67/22

(57) ABSTRACT

A network system stores in a database, a record associated with a service for a requesting user and provided by a service provider. The record can indicate a starting event for the requested service, including a start time. During a duration of time subsequent to the start time and before determining an end event for the service, the network system receives an event indication from a provider device of the service provider or a user device of the requesting user. The event indication can include audio data captured by the provider device or the user device. The network system can analyze the event indication to determine whether a safety event has occurred. In response to determining that the safety event has occurred, the network system can perform one or more safety operations. The safety operations can include transmitting a notification to the provider device and/or the user device.

### BACKGROUND

A network service can manage a service rendered by service providers for one or more requesting users. Sometimes, events that may affect the well-being or safety of the service provider and/or users may arise during the provisioning of the requested service by the service provider.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network system in communication with a provider device and a customer device, in accordance with examples described here;

FIG. 2 is a block diagram illustrating an example network system in communication with a plurality of provider devices and a plurality of user devices, in accordance with examples described herein;

FIG. 3 is a flow chart describe an example method performed by a provider device or a user device, in accordance with examples described herein;

FIGS. 4A and 4B are flow charts describing example methods of receiving and processing event indications by an example network system, according to examples described herein;

FIG. 5 is a block diagram illustrating an example user device executing and operating a designated user application for communicating with a network service, according to examples described herein;

FIG. 6 is a block diagram illustrating an example service provider device executing and operating a designated service provider application for communicating with a network service, according to examples described herein; and

FIG. 7 is a block diagram that illustrates a computer system upon which examples described herein may be implemented.

### DETAILED DESCRIPTION

A network service, which is implemented by a computer system(s) (referred to herein as a “network system” for purposes of simplicity), is provided herein that links service providers (e.g., drivers, couriers, autonomous vehicles (AVs), etc.) with requesting users throughout a given geographic region (e.g., a metroplex such as the San Francisco Bay Area). In doing so, the network service communicates with a pool of service providers in the given geographic region, each operating a vehicle for providing services and one or more computing devices (“service provider devices” or “provider devices”). The network system receives requests for services (e.g., a transport service, a delivery service, etc.) from requesting users via a designated user or client application (“user application”) executing on the users' mobile computing devices (“user devices”). In response, the network system identifies one or more available service providers to fulfill each user's request.

According to embodiments, the network system and remote devices can detect and respond to the occurrence of safety events during the provisioning of the requested service by the service provider for the requesting user. As used herein, safety events can include actual or potential interpersonal conflicts (e.g., argument, disagreement, etc.) between the service provider and the user, between users, or between the user (or the service provider) and a third party. Safety events can also include to traffic-related incidents (e.g., collision, impact, accident, etc.) involving a vehicle associated with the service provider and/or the user. In addition, safety events can include events (e.g., gunshots, explosions, other accidents, etc.) that are external to the monitored environment but may affect or impact the safety of the service provider and/or the user, or others in the general public.

In various aspects, the network system is configured to receive event indications from a remote device (e.g., the provider device and/or the user device). Remote devices can monitor an environment (“monitored environment”) (e.g., passenger cabin of a vehicle) of the service provider and/or the user to generate event indications. The monitored environment can also include a nearby region of the service provider and/or the user (e.g., outside the vehicle). The remote devices can monitor sound, lighting, air pressure, and/or other characteristics of the monitored environment to generate event indications. For example, the remote devices can generate an event indication in response to detecting an elevation in pitch or volume of sound captured within the monitored environment. The remote devices can also generate an event indication in response to detecting air pressure variations in the monitored environment (e.g., due to opening or closing of a door). Furthermore, the remote device(s) can generate an event indication in response to detecting acceleration (e.g., using one or more accelerometers) that is above a certain threshold (e.g., indicating a vehicular collision or impact). In some examples, the remote device(s) can perform processing on the captured audio (e.g., eliminate or reduce background noise, normalize audio levels, etc.). The remote device(s) can capture audio and/or video from the monitored environment for transmission to the network system as part of the event indications. The remote device(s) can include one or more microphones for detecting changes in audio volume or pitch, capturing audio, and/or detecting changes in air pressure of the monitored environment.

In certain implementations, the remote devices can be configured to monitor certain characteristics of the monitored environment only while a requested service is being provisioned. For instance, in the context of a transport service (e.g., in which the service provider fulfills the requested service by picking up the requesting user and transporting him or her to a destination location), the remote devices can be configured to only monitor or capture sound within the passenger cabin of a vehicle operated by the service provider while the requesting user is in the vehicle (e.g., after pick-up and before drop-off). The network system can determine a start time associated with the transport service (e.g., based on the service provider arriving at the pick-up location, based on a user or service provider input, based on an event indication indicating that a door of the vehicle has opened and closed, etc.) and an end event for the service (e.g., based on the service provider arriving at the drop-off location, based on a user or service provider input, based on an event indication indicating that a door of the vehicle has opened, etc.). The network system can instruct the remote devices to monitor the environment in a time duration between the start event and the end event. In this manner, the monitoring can be selectively performed based on a status of the requested service. In one example, the network system can determine a status of the requested service based on respective locations of the service provider and/or the requesting user (e.g., using geo-aware resources on the provider device and the user device) and/or based on received inputs from a remote device (e.g., an indication that the user has been picked up or dropped off). In other examples, the service provider or the requesting user can update the status of the service using the provider application or the user application, respectively. In addition to or as an alternative, the remote devices can be configured to monitor one or more characteristics of the monitored environment to determine the status of the service. For instance, a remote device can be configured to determine the status of the service based on a variation in air pressure in the passenger cabin of the vehicle indicating an opening or closing of a door.

According to embodiments, in response to receiving an event indication, the network system can verify the occurrence of a safety event triggering the received event indication. In some examples, the network system can verify an event indication generated by a first remote device (e.g., a provider device) by causing a second remote device (e.g., a user device) to initiate monitoring of the monitored environment. For example, in response to receiving, from a provider device, a first event indication corresponding to detecting an elevated tone or volume in sound captured within the monitored environment, the network system can communicate with a user device to instruct the user device to begin monitoring the monitored environment and/or capturing sound within the monitored environment. If the user device generates a second event indication in response, the network system can proceed with performing or initiating safety operations in response. On the other hand, if the user device does not generate an event indication, the network system can ignore the first event indication generated by the provider device. In certain circumstances, such as after repeatedly detecting false positive event indications, the network system can transmit notifications to the provider device informing the service provider that the provider device may need to undergo troubleshooting or service. In addition or as an alternative, the network system can communicate with the provider device to turn off the provider device's monitoring capabilities.

In various aspects, in response to receiving an event indication, the network system can perform operations to determine a type and/or a severity of the detected safety event. The network system can receive, from the remote devices (e.g., as part of the event indication), information sufficient to determine an event type (e.g., a verbal disagreement, a traffic accident, etc.) corresponding to the detected safety event. As one example, the network system can analyze captured audio to determine an event type. The network system can further determine, using information transmitted from the remote devices, a severity associated with the detected safety event. In the examples described herein, the safety operations performed or initiated by the network system can depend on the event type and/or the severity.

According to embodiments, the network system can perform or initiate a number of safety operations to resolve or mitigate a detected safety event. The safety operations can be performed or initiated in response to receiving event indications from a remote device(s). The safety operations can be based on the detected safety event. For instance, if the detected safety event is an interpersonal conflict (e.g., argument, disagreement, etc.), the network system can perform safety operations to de-escalate any actual or potential conflicts and to ensure the safety of the service provider and the user(s). As another example, if the detected safety event is an external event, the network system can determine a location of the external event (e.g., by analyzing a plurality of event indications received from a plurality of remote devices at various locations triggered by the external event) and transmit information regarding the external event (e.g., location, timing, severity, type of event, etc.) to third parties such as local authorities. Furthermore, if the detected safety event is a traffic incident (e.g., a collision, accident, etc.), the network system can transmit information regarding the traffic incident (e.g., location, timing, severity, etc.) to third parties such as local authorities.

According to embodiments, the network system can transmit data corresponding to one or more event notifications to the remote device(s) in response to receiving an event indication. An event notification can cause the recipient remote device to display a notification and/or to generate an audible alert. The event notification can include instructions or suggestions to, for example, de-escalate any actual or potential interpersonal conflicts. For instance, the event notification can suggest to the recipient (e.g., service provider, user, etc.) to lower his or her volume of speech. The event notification can also include a query to the recipient prompting for details regarding any actual or potential conflict occurring at the time. The event notification can require the recipient to acknowledge receipt or to respond in some manner.

In the examples described herein, the network system can selectively perform safety operations in response to, for example, receiving an additional event indication from a remote device(s) (e.g., indicating continued elevation of tone or volume in the sound captured within the monitored environment) or not receiving a response to an event notification. For instance, if one or more additional event indications are received or if no response to the event notification is received from remote device(s) (e.g., the provider device and/or the user device) within a timeout period, the network system can perform one or more safety operations. Such safety operations can include initiating audio and/or video communications with the provider device and/or the user device (e.g., with a communication center). In addition, the network system can contact relevant third parties such as local authorities (e.g., police) or a third party security company under appropriate circumstances. For instance, the network system can connect the user and/or the service provider with authorities or transmit an incident report to the authorities. Safety operations can further include updating a service route of the service provider.

In certain implementations, the network system can receive information (e.g., as part of the event indication) from the remote devices that enable the network system to determine a concerned party in association with a detected safety event. As used herein, a concerned party can be an individual or a group of individuals (e.g., service provider, user, etc.) determined by the network system as being likely to be concerned or aggrieved by the detected safety event. For instance, in response to receiving an event indication corresponding to a verbal disagreement between a service provider and a user in which the user is determined to be initiating an interpersonal conflict (e.g., determined by detecting elevated tone or volume, use of certain keywords, etc.), the network system can determine that the service provider is a concerned party. The network system and/or remote device(s) can perform safety operations based on a determination of a concerned party. For instance, different event notifications may be transmitted to the provider device and the user device based on the determination of the concerned party. As an example, the non-concerned party may receive an event notification with suggestions to de-escalate any actual or potential conflicts, while the concerned party may receive an event notification with queries regarding his or her well-being. Furthermore, if the service provider is determined to be a concerned party, the network service can update a service route for the service provider to follow. The updated service route can include a safe location (e.g., a police station, a well-lit public area, etc.).

In certain implementations, the network system and/or the remote devices can detect trigger phrases uttered by the service provider or the user. The detection of trigger phrases can cause the network system to perform or initiate specific safety operations. For instance, the network system and/or the remote devices can recognize phrases such as “Call the Police!” uttered by the service provider or the user. In response, the network system can perform specific safety operations such as contacting local authorities.

In some examples, the network system can be configured to determine a location of an external safety event (e.g., a gunshot, an explosion, etc.). By receiving a plurality of event indications from a plurality of remote devices, the network system can determine which of the plurality of event indications were generated in response to the occurrence of the external safety event. Thereafter, the network system can localize the source of acoustic signals associated with the external safety event by analyzing the event indications and the locations of the plurality of remote devices. For instance, the network system can perform source localization based on the times of receipt of the event indications.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Some examples are referenced herein in context of an autonomous vehicle (AV) or self-driving vehicle (SDV). An AV or SDV refers to any vehicle which is operated in a state of automation with respect to steering and propulsion. Different levels of autonomy may exist with respect to AVs. For example, some vehicles may enable automation in limited scenarios, such as on highways, provided that drivers are present in the vehicle. More advanced AVs can drive without any human assistance from within or external to the vehicle. Such vehicles are often required to make advanced determinations regarding how the vehicle behaves given challenging surroundings of the vehicle environment.

System Descriptions

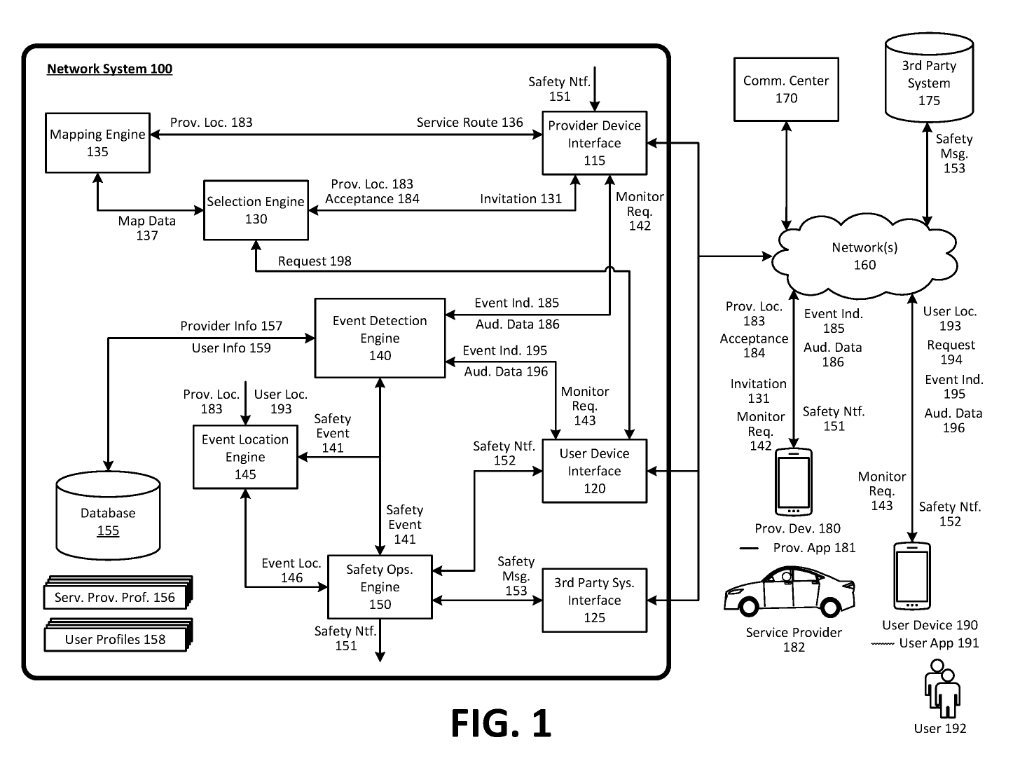

FIG. 1 is a block diagram illustrating an example network system in communication with user and provider devices, in accordance with examples described herein. The network system 100 can manage a network service that connects requesting users 192 with service providers 182 that are available to service the users' service requests 194. The network service can provide a platform that enables on-demand services (e.g., ride-sharing services, transport services, delivery services, etc.) between requesting users 192 and available service providers 182 by way of a user application 191 executing on the user devices 190, and a service provider application 181 executing on the provider devices 180. As used herein, a user device 190 and a provider device 180 can comprise a computing device with functionality to execute a designated application corresponding to the network service managed by the network system 100. In many examples, the user device 190 and the provider device 180 can comprise mobile computing devices, such as smartphones, tablet computers, VR or AR headsets, on-board computing systems of vehicles, smart watches, and the like. In addition, the service provider 181 and provider device 180 can be on-board computing systems of autonomous vehicles.

According to embodiments, the network system 100 can include a user device interface 120 to communicate with user devices 190 over one or more networks 160 via a user application 191. According to examples, a requesting user 192 wishing to utilize the network service can launch the user application 191 and transmit a service request 194 over the network 160 to the network system 100. In certain implementations, the requesting user 192 can view multiple different service types managed by the network system 100, such as ride-pooling, a basic ride share service, a luxury vehicle service, a van or large vehicle service, a professional service provider service (e.g., where the service provider is certified), a self-driving vehicle transport service, and the like. The network system 100 can utilize the service provider locations 182 to provide the user devices 160 with ETA data of proximate service providers for each respective service. For example, the user application 191 can enable the user 192 to scroll through each service type. In response to a soft selection of a particular service type, the network system 100 can provide ETA data on a user interface of the user app 191 that indicates an ETA of the closest service provider for the service type, and/or the locations of all proximate available service providers for that service type. As the user scrolls through each service type, the user interface can update to show visual representations of service providers for that service type on a map centered around the user 192 or a start location (e.g., a pick-up location where the requesting user rendezvouses with a service provider) set by the user. The user can interact with the user interface of the user app 191 to select a particular service type, and transmit a service request 194.

In various implementations, the network system 100 can further include a selection engine 130 to process the service requests 194 in order to select service providers 182 to service the service requests 194. The network system 100 can include a provider device interface 115 to communicate with the provider devices 180 via the service provider application 185. In accordance with various examples, the provider devices 180 can transmit real-time location information using geo-aware resources of the provider devices 180 (e.g., GPS or GLONASS). These service provider locations 183 can be utilized by the selection engine 130 to identify a set of candidate service providers 182, in relation to the start location, that can service the service request 194. In certain implementations, the network system 100 can also select a proximate self-driving vehicle (SDV) to service the service request 194. Thus, the pool of proximate candidate service providers in relation to a start location can also include one or more SDVs operating throughout the given region.

In some aspects, the network system 100 can include a mapping engine 135, or can utilize a third-party mapping service, to generate map data 137 and or traffic data in the environment surrounding the start location. The mapping engine 135 can receive the service provider locations 183 and input them onto the map data 137. The selection engine 130 can utilize the current service providers locations 183 in the map data 137 (e.g., by setting a geo-fence surrounding the start location) in order to select an optimal service provider 189 to service the service request 194. As provided herein, the optimal service provider can be a service provider that is closest to the requesting user 192 with respect to distance or time, or can be a proximate service provider that is optimal for other reasons, such as the service provider's experience, the amount of time the service provider has been on the clock, the service provider's current earnings, and the like.

Once the optimal service provider is selected, the selection engine 130 can generate an invitation 131 to service the service request 194, and transmit the invitation 131 to the provider device 180 of the optimal service provider via the service provider application 185. Upon receiving the invitation 132, the optimal service provider can either accept or reject the invitation 132. Rejection of the invitation 132 can cause the selection engine 130 to determine another optimal service provider from the pool of available service providers to service the service request 194. However, if the optimal service provider accepts (e.g., via an acceptance input), then an acceptance 184 can be transmitted to the selection engine 130 of the network system. The selection engine 130 can generate and transmit a confirmation 134 of the optimal service provider 189 to the requesting user 192 via the user application 191 on the requesting user's 192 computing device 190.

Still further, the network system 100 can create and store a record, such as in a service record database, for the requested service. The record can include or be associated with an identifier of the user, data from the service request 194 (e.g., start location, destination location, service type, payment profile, etc.), and an identifier of the service provider. The network service 100 can update the record (or associate data with the record) with event data, such as a location and time when the service request 194 was made or received, or when the status of the service changes based on location information and/or user input. For example, the network service 100 can store location and time information (and/or status information) when the service provider is selected, when the service provider accepts the service, when the service provider arrives at the start location, when the service starts, when the service ends, etc.

According to embodiments, the provider device 180 and/or the user device can monitor for safety events while the requested service is being provided by the service provider 182. For example, the provider device 180 can be configured to monitor for safety events after the service provider 182 rendezvouses with the requesting user 192. Similarly, the provider device 180 can be configured to begin monitoring for safety events after the service provider 182 departs and travels to the start location to rendezvous with the requesting user 192. The provider device 180 can end monitoring for safety events after the requested service is completed (e.g., after arriving at the service location). In some examples, the service provider 182 can simultaneous service multiple service requests (e.g., a ride-pooling service) for two or more users 192. In these examples, the provider device 180 can be configured to monitor for safety events as long as service is being performed by the service provider 182 for any one user 192. The provider device 180 can be configured to begin monitoring for safety event in response to receiving a monitoring request 142 from the network system 100. In addition, or as an alternative, the provider device 180 can determine whether to monitor for safety events based on the location of the provider device 180. For instance, the provider device 180 can begin monitoring for safety events once the service provider 182 arrives at a start location of the service request 194. Similarly, the provider device can stop monitoring for safety events once the service provider 182 arrives at a service location of the service request 194. Similar to the provider device 180, the user device 190 can monitor for safety events in response to receiving a monitoring request 143 from the network system 100. The user device 190 can also determine whether to monitor for safety events based on the location of the user device 190.

In some examples, the provider device 180 and the user device 190 include on-board microphones for detecting changes in audio levels and/or capturing audio in an environment monitored by the provider device 180 and the user device 190 (e.g., a passenger compartment of a vehicle operated by service provider 180, a passenger compartment of an AV, etc.). The provider device 180 and user device 190, while monitoring the environment, can generate event indications 185 and 195, respectively, in response to detecting changes in audio volume and/or pitch. For instance, while monitoring the environment, the provider device 180 and the user device 190 can continuously capture audio data using the on-board microphones. The devices 180 and 190 can be configured to discard captured audio data except when a potential safety event is detected. When a potential safety event is detected, the devices 180 and 190 can store or cache captured audio data corresponding to the potential safety event for processing and transmission to the network system 100. The provider device 180 and the user device 190 can also perform audio processing on the captured audio data to, for example, to filter or reduce background noise.

According to embodiments, the provider device 180 and the user device 190 can determine that a potential safety event has occurred by detecting for elevations in volume and/or pitch in the captured audio data. In response, the devices 180 and 190 can generate event indications 185 and 195, respectively. In certain implementations, the event indications 185 and 195 can be generated if captured audio deviates from normal audio properties by some margin. For instance, the provider device 180, the user device 190, and/or the network system 100 can determine normal audio properties (e.g., volume, tone, pitch, etc.) for the monitored environment. The normal audio properties of the monitored environment can correspond to properties related to road noise, noise from an external environment, and the like under normal circumstances. In this manner, a normally loud or quiet environment of the service provider 182 and user 192 can be taken into account in generating event indications 185 and 195. The normal audio properties of the monitored environment can be based on the location or a rate of travel of the service provider 182. For instance, the normal audio volume of the monitored environment can be adjusted higher if the service provider 182 is located in a particularly noisy urban environment or if the service provider 182 is traveling at a high rate (e.g., causing a high amount of road noise). In addition, the provider device 180, the user device 190, and/or the networking system 100 can determine normal audio properties of speech of the service provider 182 and/or the user 192. For instance, the provider device 180, during monitoring of the environment, can record average speech volumes of the service provider 182. Such average speech volume of the service provider 182 can be stored in a database 155 of the network system 100 as part of the service provider profile 156 corresponding to the service provider 182 and used as a normal audio property for the service provider 182. The provider device 180 can generate an event indication if volume of speech audio captured during monitoring of the environment exceeds the average speech volume of the service provider 180 by a certain margin (e.g., 5 dB or a standard deviation).

In some examples, the event indications 185 and 195 can include captured audio data 186 and 196, respectively. The provider and user devices 180 and 190 can transmit captured audio data corresponding to the detected potential safety event to the network system 100 for additional analysis and confirmation. The provider and user devices 180 and 190 can, for example, transmit a short duration of captured audio (e.g., 1 to 5 seconds in length) corresponding to the detected potential safety event to the network system 100. Other captured audio data (e.g., not corresponding to any detected potential safety events) can be discarded. In some examples, the provider and user devices 180 and 190 can perform analyses on the other captured audio data to, for example, determine normal audio properties of the monitored environment, of the service provider 182, and/or of the user 192.

According to embodiments, the network system 100 can include an event detection engine 140 to analyze data received from the provider device 180 and/or the user device 190 to determine whether a safety event has occurred. The event detection engine 140 can receive event indication 185 and audio data 186 from the provider device 180. The event detection engine 140 can also receive event indication 195 and audio data 196 from the user device 190. In some examples, the event detection engine 140 can perform audio processing on the audio data 186 and audio data 196 to further optimize the received audio data. For example, the event detection engine 140 can filter or remove background or road noise.

In some examples, the event detection engine 140 can verify the detection of a potential safety event or can determine if a detected potential safety event is of continued relevance. For example, in response to receiving the event indication 185 from the provider device 180, the event detection engine 140 can generate a monitoring request 143 to be transmitted to the user device 190. In response, the user device 190 can initiate monitoring of the monitored environment. If event indication 195 is received from the user device 190, the event detection engine 140 can determine that the detected safety event is still and the network system 100 can perform a number of safety operations in response. If the network system 100 does not receive an event indication from the user device 190, the event detection engine 140 can determine that the event indication 185 received from the provider device 180 is a false positive or that the detected safety event is no longer of relevance. In this manner, the network system 100 can leverage additional remote devices to confirm or verify detected potential safety events without causing the additional remote devices to continuously monitor the environment. This can result in advantages such as energy savings and reduced processing requirements on the additional remote devices. In some examples, the network system 100 can also verify the detection of a potential safety event by receiving additional event indications from the provider device 180.

In various aspects, the event detection engine 140 can determine whether a detected safety event 141 corresponds to an external safety event (e.g., safety event occurring outside of the monitored environment of the service provider 182 and the user 192). Such external safety events may include gunshots, explosions, and the like. The event detection engine 140 can be configured to detect whether a received event indication 185 or 195 corresponds to an external safety event based on the characteristics of captured audio data 186 or 196. For instance, if the captured audio data 186 matches audio characteristics of gunshots, the event detection engine 140 can determine that the safety event 141 corresponds to an external safety event. In addition or as an alternative, the event detection engine 140 can determine whether a received event indication 185 or 195 corresponds to an external safety event based on receiving a plurality of event indications generated by provider and/or user devices located near the external safety event. For example, if the event detection engine 140 receives a plurality of event indications having similar characteristics (e.g., timing, location, audio characteristics) from a plurality of provider and/or user devices, the event detection engine 140 can determine that the detected safety event 141 corresponds to an external safety event.

In certain implementations, in response to determining that the detected safety event 141 corresponds to an external safety event, an event location engine 145 of the network system 100 can determine an approximate event location 146 of a detected safety event 141. The event location engine 145 can determine the approximate event location 146 using timing and location information of the received event indications that correspond to the safety event 141. For instance, the event indications (e.g., event indication 185 and event indication 195) can include timing information regarding when the safety event was detected by the provider and/or user devices. In addition, or as an alternative, the event location engine 145 can utilize the time of receipt of the event indications in determining the approximate event location 146. For instance, the event location engine 145 can determine, based on a time of receipt of the event indication 185 from the provider device 180 and a network latency associated with the provider device 180, a time at which the provider device 180 detected the external safety event. In addition, the event location engine 145 can also receive location information (e.g., provider location 183 and user location 193) of the provider devices and user devices that generated the event indications. Furthermore, the event location engine 145 can determine the approximate location of the external event based on information such as the strength (e.g., volume) of the audio signal of the external safety event detected by the remote devices. For instance, the event location engine 145 can determine that the location of the external safety event is closer to a first remote device having a detected a strong audio signal related to the safety event than to a second remote device having detected a weak audio signal related to the safety event.

According to embodiments, the network system 100 can include a safety operations engine 150 to perform safety operations in response to detected safety events. The safety operations engine 150 can selectively perform safety operations based on characteristics or properties of the safety event 141 (e.g., event type, event severity). As one example, if the event type is determined by the event detection engine 140 as an interpersonal conflict (e.g., argument, disagreement, etc.), for example, between the service provider 182 and the user 192, the safety operations engine 150 can generate safety notifications 151 and 152 to be transmitted to the provider device 180 and the user device 190. The safety notifications 151 and 152 can be based on the safety event 141 (e.g., severity, concerned party). For instance, if the event detection engine 140 determines that the service provider 182 is the concerned party, the safety operations engine 150 can generate safety notification 151 to be transmitted to the provider device 180 that includes queries regarding the well-being of the service provider 182. Furthermore, the safety operations engine 150 can also generate safety notification 152 for the user 192 (e.g., the non-concerned party), with suggestions regarding de-escalating the interpersonal conflict. As another example, if the event type is determined by the event detection engine 140 as an external safety event, the safety operations engine 150 can generate a safety message 153 to be transmitted to a third-party system (e.g., a computer system of local authorities such as the police) that includes the determined event location 146.

In some examples, the safety operations engine 150 can selectively one or more safety operations based on receiving additional event indications. For instance, the safety operations engine 150 can determine, based on the

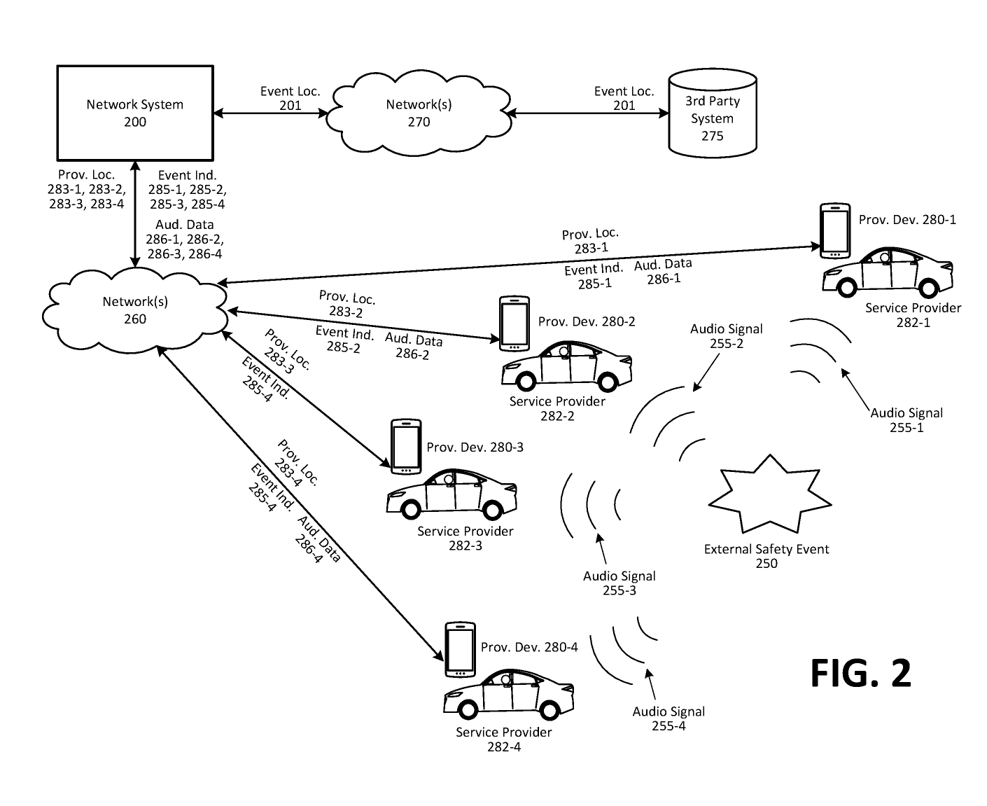

FIG. 2 is another block diagram illustrating an example network system in connection with a plurality of provider devices and a plurality of user devices, in accordance with examples described herein. In the below discussion of FIG. 2, reference may be made to features and examples shown and described with respect to FIG. 1.

Referring to FIG. 2, network system 200 can communicate with a plurality of remote devices, including provider devices 280-1, 280-2, 280-3, 280-4, operated by service providers 282-1, 282-2, 282-3, 282-4, respectively. The network system 200 can communicate with the plurality of provider devices 280-1, 280-2, 280-3, 280-4 to connect the service providers 282-1, 282-2, 282-3, 282-4 to requesting customers of a service (e.g., transport service, delivery service, etc.) managed by the network system 200. The requesting customers operate customer devices (not shown) that separately communicate with the network system 200. For instance, the requesting customers can operate their respective customer devices to generate requests to the network system 200 corresponding to requests for services. In response to each request, the network system 200 can select a service provider (e.g., service providers 282-1, 282-2, 282-3, 282-4) to fulfill the received request and transmit one or more invitations to the selected service provider. The service providers can accept the received invitations to begin offering the requested services to the requesting customers.

During the provisioning of the requested services by service providers 282-1, 282-2, 282-3, 282-4, the provider devices 280-1, 280-2, 280-3, 280-4 can be configured to monitor the environments of the service providers 282-1, 282-2, 282-3, 282-4 (e.g., interior of passenger compartment of vehicles operated by the service providers) to detect the occurrence of an external safety event 250. The provider devices 280-1, 280-2, 280-3, 280-4 can monitor the environments to detect audio signals 255-1, 255-2, 255-3, 255-4 generated by the external safety event 250. The external safety event 250 can be a gunshot, explosion, collision, and the like. Provider device 280-1, for instance, can be configured to monitor and detect audio signal 255-1 generated by the external safety event 250 when the service provider 282-1 travels to pick up a requesting customer or after picking up the requesting customer and traveling to a destination location specified by the requesting customer.

Upon detecting audio signals 255-1, 255-2, 255-3, 255-4, the provider devices 280-1, 280-2, 280-3, 280-4 can transmit event indications 285-1, 285-2, 285-3, 285-4 to the network system 200 to indicate that a potential safety event has been detected. The provider devices 280-1, 280-2, 280-3, 280-4 can record the detected audio signals 255-1, 255-2, 255-3, 255-4 and transmit the recorded audio signals to the network system 200 as audio data 286-1, 286-2, 286-3, 286-4, respectively, for analyses. The provider devices 280-1, 280-2, 280-3, 280-4 can further transmit information that can be used by the network system 200 to verify the occurrence of the external safety event 250 and/or to determine the location of the external safety event 250. For instance, the provider device 280-1 can transmit, to the network system 200, a time of detection of the audio signal 255-1. The provider device 280-1 can also transmit to the network system 200 provider location 283-1 indicating the location of the service provider 280-1 at the time the audio signal 255-1 was detected. Provider location 283-1 can be determined using, for example, a geo-aware resource such as a GPS receiver within the provider device 280-1, and/or cellular triangulation.

According to embodiments, the network system 200 can determine the approximate location of the external safety even 250 using the times at which the provider devices 280-1, 280-2, 280-3, 280-4 detected the audio signals 255-1, 255-2, 255-3, 255-4. By comparing the times of detection (e.g., determined and transmitted by the provider devices 280-1, 280-2, 280-3, 280-4), the network system 200 can determine the respective distances between the service providers 282-1, 282-2, 282-3, 282-4 and the external safety event 250. Using the received provider locations 283-1, 283-2, 283-3, 283-4 and the respective distances between the service providers 282-1, 282-2, 282-3, 282-4, and the external safety event 250, the network system 200 can determine an approximate location of the external safety event 250.

In some examples, the network system 200 can also approximate the times of detection by the provider devices 280-1, 280-2, 280-3, 280-4 based on the respective times the event indications 285-1, 285-2, 285-3, 285-4 were received by the network system 200. The network system 200 can determine respective performance parameters for each of the provider devices 280-1, 280-2, 280-3, 280-4. The performance parameters can include information regarding audio processing latency associated with a provider device's processing of detected audio signals (e.g., audio signal 255-1) and network latency associated with the provider device's communication link with the network system 200 over the network(s) 260. Using the performance parameters and the times of receipt of the event indications 285-1, 285-2, 285-3, 285-4, the network system 200 can estimate the times the audio signals 255-1, 255-2, 255-3, 255-4 reached the provider devices 280-1, 280-2, 280-3, 280-4. Thereafter, the network system 200 can use the estimated times to determine the approximate location of the external safety event 250.

In certain implementations, the network system 200 can analyze the received audio data 283-1, 283-2, 283-3, 283-4 to determine (or aid in determining) the approximate location of the external safety event 250. Audio signals 255-1, 255-2, 255-3, 255-4 detected and captured by the provider devices 280-1, 280-2, 280-3, 280-4 can have different characteristics and properties due various factors such as the distances between respective locations of the service providers 282-1, 282-2, 282-3, 282-4 and the location of the external safety event 250, the direction and speed of travel of the service providers 282-1, 282-2, 282-3, 282-4, the environment surrounding the service providers 282-1, 282-2, 282-3, 282-4, and the like. For example, the network system 200 can determine, based on a pitch of a captured audio signal (or relative pitch compared with other captured audio signals) that a service provider is moving towards or away from the location of the external safety event 250.

According to embodiments, the network system 200 can communicate with a third party system 275 via network(s) 270. The third party system 275 can be one or more computer systems associated with local authorities (e.g., police, paramedics, and the like) or other third party entities (e.g., security company) that can respond to the external safety event 250. The network(s) 270 can be an open network (e.g., the Internet), a dedicated connection (e.g., a dedicated fiber connection), or a private connection (e.g., a virtual private network) between the network system 200 and the third party system 275. The network system 200 can transmit an event location 201 representing the determined approximate location of the external safety event 250 to the third party system 275.

Methodology

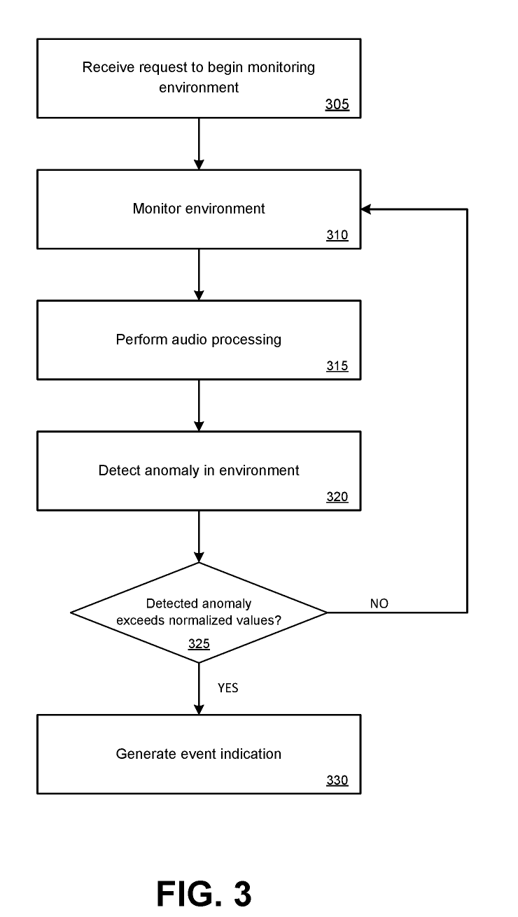

FIG. 3 is a flow chart describe an example method performed by a provider device or a user device, in accordance with examples described herein. In the below discussion of FIG. 3, reference may be made to features and examples shown and described with respect to FIGS. 1 and 2. Furthermore, the process described with respect to FIG. 3 may be performed by example provider and user devices such as the ones shown and described with respect to FIGS. 1 and 2.

Referring to FIG. 3, a remote device (e.g., provider device 180 or 280 of FIGS. 1 and 2, user device 190 of FIG. 1) in communication with a network system (e.g., network systems 100 or 200 of FIGS. 1 and 2) can generate an event indication in response to detecting anomalies in an environment monitored by the remote device. The remote device can receive, from the network system over a network, a request to begin monitoring the environment (305). The monitored environment can be, for example, a passenger compartment of a vehicle operated by the service provider. In the context of a provider device, the request can be transmitted by the network system based on a status associated with the service provider. For instance, once a service provider accepts an invitation to provide a requested service, the network system can change a status associated with the service provider (e.g., from “Available” to “En-Route to Pick Up User”). In response to the status change, the network system can generate and transmit the request to the provider device to begin monitoring the environment. As another example, the network system can generate the request in response to a status change indicating that the service provider has rendezvoused with the requesting user (e.g., status change from “En-Route to Pick Up User” to “En-Route to Destination”). In certain embodiments, the request to begin monitoring the environment can be generated by the remote device itself. The remote device can generate the request to begin monitoring the environment based on, for example, location data generated by one or more geo-aware resources (e.g., GPS receiver) within the remote device. For instance, a provider device can generate a request to begin monitoring the environment in response to location data indicating that the service provider has arrived at a rendezvous location with the requesting user.

According to embodiments, in response to receiving the request to begin monitoring the environment (e.g., from the network system or from the remote device itself), the remote device monitors the environment for anomalies (310). The remote device can detect for audio anomalies. For instance, the remote device can continuously capture audio using a microphone to detect for changes in audio pitch and/or volume. The audio signals captured by the microphone can be temporarily stored in a cache memory in, for example, five or ten second intervals. The cached audio signals can be processed and later transmitted to the network system for further analysis. The remote device can also detect changes in air pressure that can indicate, for example, a door of the passenger compartment being opened or closed. In some implementations, the remote device can also monitor, using one or more accelerometers, the acceleration of the remote device that can indicate the occurrence of safety events (e.g., vehicular accident).

According to embodiments, the remote device can perform audio processing on the captured audio signals (315). Such audio processing can include filtering out background noise. For instance, the remote device can perform filtering on particular audio frequencies associated with background noise (e.g., traffic noise, road noise) to remove or reduce the background noise. In some examples, the audio processing includes determining a normalized values (e.g., for volume, pitch, etc.) for triggering the generation of event indications. For instance, the remote device can determine, over time, a normalized volume for a particular environment. For example, a first vehicle operated by a first service provider may have a quieter passenger compartment than a second vehicle operated by a second service provider. By monitoring the audio environment of both service providers over time, the provider devices of the first and second service providers can determine different normalized volumes for the two service providers that are used in the generation of event indications.

In various aspects, the remote device can detect an anomaly in the monitored environment (320). The anomaly can correspond to an elevation in audio volume in the monitored environment. At step 325, the remote device compares the detected anomaly (e.g., elevated audio volume) with normalized values for the environment determined over time to determine whether the detected anomaly exceeds the normalized values (e.g., by a threshold value). In the event that the detected anomaly does not exceed normalized values, the remote device ignores the detected anomaly and continues to monitor the environment. On the other hand, if the detected anomaly exceeds the normalized values, the remote device can generate an event indication for transmission to the network system (330).

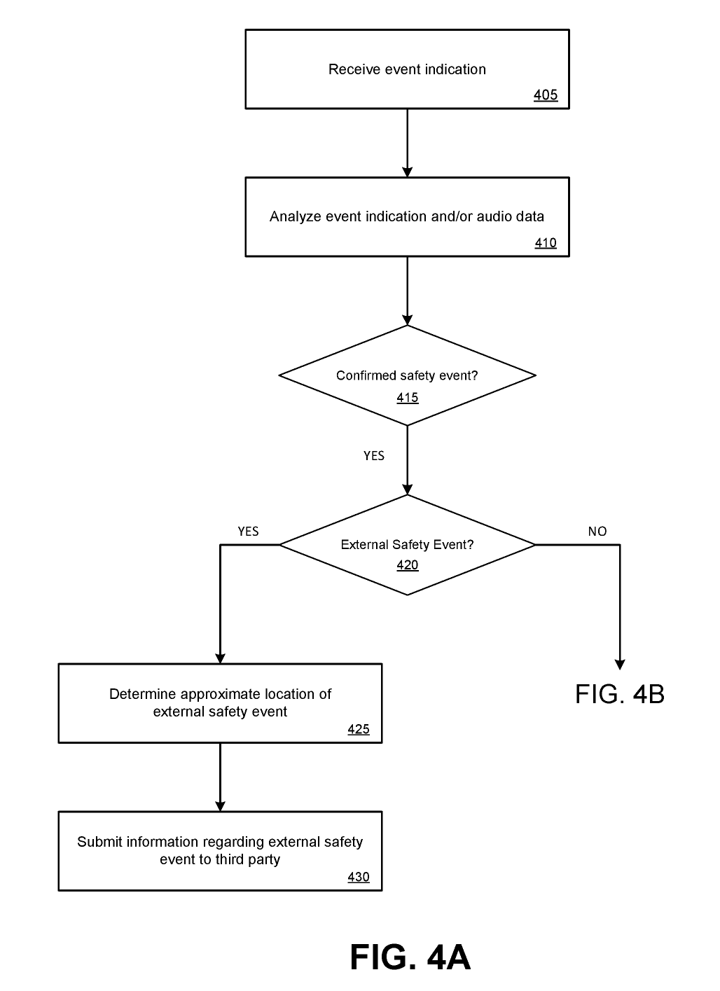

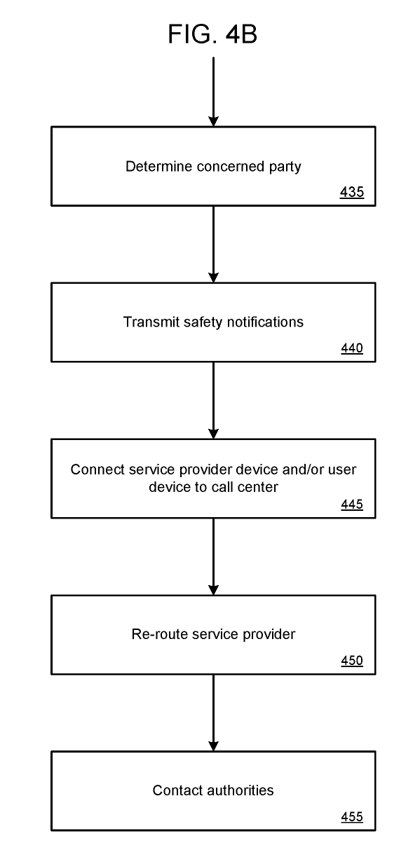

FIGS. 4A and 4B are flow charts describing example methods of receiving and processing event indications by an example network system, according to examples described herein. In the below discussion of FIGS. 4A and 4B, reference may be made to features and examples shown and described with respect to FIGS. 1 and 2. Furthermore, the processes described with respect to FIGS. 4A and 4B may be performed by an example network system such as the ones shown and described with respect to FIGS. 1 and 2.

Referring to FIG. 4A, a network system (e.g., network systems 100 and 200 of FIGS. 1 and 2, respectively) can receive an event indication (e.g., event indication 185 of FIG. 1 and event indications 285-1 to 285-4 of FIG. 2) from a remote device (e.g., provider device 180 of FIG. 1 and provider devices 280-1 to 280-4 of FIG. 2) (405). The event indication can be generated by the remote device in response to detecting an anomaly in an environment monitored by the remote device. The anomaly may indicate the occurrence of a safety event.

In some examples, the network system analyzes the event indication and/or audio data (e.g., audio data 186 of FIG. 1 and audio data 286-1 to 286-4 of FIG. 2) transmitted from the remote device (410). The network system can, for example, perform audio processing on the received audio data to reduce background noise and improve the clarity of the audio data.

According to embodiments, the network system can confirm the occurrence of the detected safety event (415). One way the network system can do so is by receiving additional event indications. In the context of an external safety event detected by a first provider device, the detected external safety event can be confirmed by receiving additional safety event indications from a second provider device located proximately to the first provider device. The network system can analyze the received event indications to ensure that they were generated in response to the same detected external safety event (e.g., based on time, location, audio data, etc.). In other contexts, in response to receiving an event indication from the first provider device, the network system can transmit, to a second remote device (e.g., a user device of a requesting user to whom the service provider is providing the requested service), a request to begin performing environment monitoring. The occurrence of the detected safety event can be confirmed if the network system receives an event indication from the second device within a certain amount of time. If the detected safety event is not confirmed (e.g., an event indication is not received from the second remote device), the network system can ignore the received event indication from the first provider device.

In certain implementations, the network system can determine whether the received indication corresponds to an external safety event (420). For example, one or more other event indications are received from one or more other remote devices located proximately to the remote device that transmitted the event indication, the network system can determine that the received event indications correspond to a single external safety event. The network system can further analyze audio data transmitted by remote devices to determine whether the received event indication corresponds to an external safety event.

If the received event indication corresponds to an external safety event, the network system can determine an approximate location of the external safety event (425) as described with respect to, for example, FIG. 2. The network system can submit information (e.g., time, determined approximate location, type, severity, etc.) of the external safety event to a third party (e.g., local authorities).

Referring to FIG. 4B, if detected safety event is not an external safety event, the network system can perform a number of safety operations in response to the detected safety event (435-455). The number of safety operations can be performed sequentially based on a determination of whether the safety event has been resolved. For instance, if the network system determines (e.g., based on receiving input from the provider device and/or user device) that the safety event has been resolved (e.g., a potential conflict has been de-escalated), the network system can cease the safety operations. On the other hand, if the network system determines that the safety event has not been resolved (e.g., based on continued receipt of event indications or if no input is received in response to safety notifications), the network system can continue to perform safety operations.

In certain implementations, the network system can determine a concerned party based on information received from the remote devices (435). Based on received audio data, for example, the network system can determine one or both of the service provider and the requesting user as the concerned party(s). For instance, in response to determining that the requesting user's voice is elevated in volume or pitch, the network system can determine the service provider to be the concerned party. As another example, in response to determining that the detected safety event is an vehicular collision, the network system can identify both the service provider and the requesting user as concerned parties.

In certain implementations, the network system can transmit safety notifications to the provider device and/or the user device (440). The safety notifications can be generated based on the determination of the concerned party. For instance, a safety notification to the non-concerned party can include information to de-escalate a potential interpersonal conflict. As another example, a safety notification to the concerned party can include a prompt (e.g., a push notification prompt) for input regarding the well-being of the concerned party.

In certain implementations, the network system is configured to connect the provider device and/or the user device to a call center (445). For instance, the network system can initiate audio or video communications between the provider device and a safety call center to resolve the detected safety event. The network system can provide, to one or more agents at the safety call center, information regarding the detected safety event. For instance, the network system can provide information regarding the location of the service provider and requesting user, type of safety event, captured audio data corresponding to the safety event, etc. Such information can aid in the resolution of the detected safety event.

In the examples described herein, the network system can re-route the service provider (450). For instance, in the event that the concerned party is the service provider, the network system can transmit updated routing information to the provider device that routes the service provider to known safe areas (e.g., an area near a local authority).

In some examples, the network system can contact authorities (e.g., local police, paramedics, etc.) on behalf of the service provider and/or requesting user (455). The network system can transmit, to the authorities, information relevant to the safety event such as the location of the service provider and requesting user and the time of occurrence of the safety event.

User Device

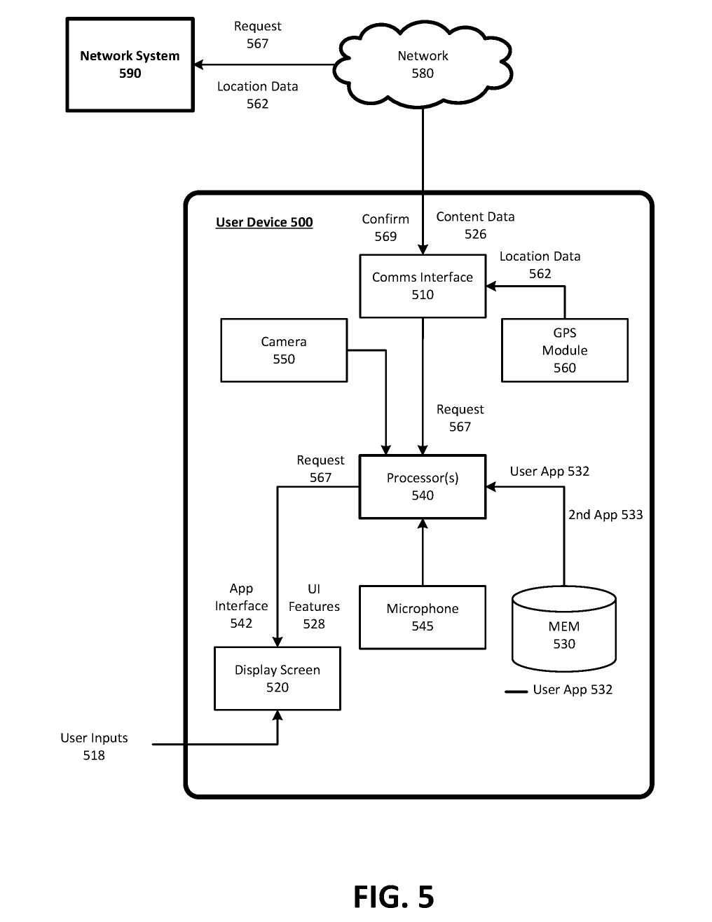

FIG. 5 is a block diagram illustrating an example user device executing and operating a designated user application for communicating with a network service, according to examples described herein. In many implementations, the user device 500 can comprise a mobile computing device, such as a smartphone, tablet computer, laptop computer, VR or AR headset device, and the like. As such, the user device 500 can include typical telephony features such as a microphone 545, a camera 550, and a communication interface 510 to communicate with external entities using any number of wireless communication protocols. In certain aspects, the user device 500 can store a designated application (e.g., a user app 532) in a local memory 530. In variations, the memory 530 can store additional applications executable by one or more processors 540 of the user device 500, enabling access and interaction with one or more host servers over one or more networks 580.

In response to a user input 518, the user app 532 can be executed by a processor 540, which can cause an app interface 542 to be generated on a display screen 520 of the user device 500. The app interface 542 can enable the user to, for example, view available items offered by nearby entities. In various implementations, the app interface 542 can further enable the user to enter or select a service location (e.g., by entering an address, performing a search, or selecting on an interactive map). Furthermore, the app interface 542 can display dynamically determined values associated with the available items. The user can generate a request 567 via user inputs 518 provided on the app interface 542. For example, the user can select one or more items from the available items in requesting the network service. In some examples, the app interface 542 can display one or more suggested or recommended items that are identified by the network system based on information specific to the user (e.g., user profile information).

As provided herein, the user application 532 can further enable a communication link with a network system 590 over the network 580, such as the network system 100 as shown and described with respect to FIG. 1. The processor 540 can generate user interface features 528 (e.g., map, request status, content cards, etc.) using content data 526 received from the network system 590 over network 580. Furthermore, as discussed herein, the user application 532 can enable the network system 590 to cause the generated user interface 528 to be displayed on the application interface 542.

The processor 540 can transmit the requests 567 via a communications interface 510 to the backend network system 590 over a network 580. In response, the user device 500 can receive a confirmation 569 from the network system 590 indicating the selected service provider that will service the request 567. In various examples, the user device 500 can further include a GPS module 560, which can provide location data 562 indicating the current location of the requesting user to the network system 590 to, for example, establish the service location.

According to embodiments, the app interface 542 can further display user interface features indicating or representing a current status of the request for service. For instance, the app interface 542 can display a progress bar indicating the current status of the user's request. The app interface 542 can also display useful information such as an estimated time of arrival of the selected service provider at the service location. In addition, the user can enter, via the app interface 542, information that may be relevant to the selected service provider such as a building entry access code, an intercom number or code, a contact phone number of the user, a cross-street etc.

In certain implementations, the local memory 530 can further store a second app 533 used to submit requests for a second service. The processor 540 is configured to execute instructions corresponding to the second app 533. The user app 532 and second app 533 can share data within the local memory 530 to exchange information related to the network service and the second service.

Service Provider Device

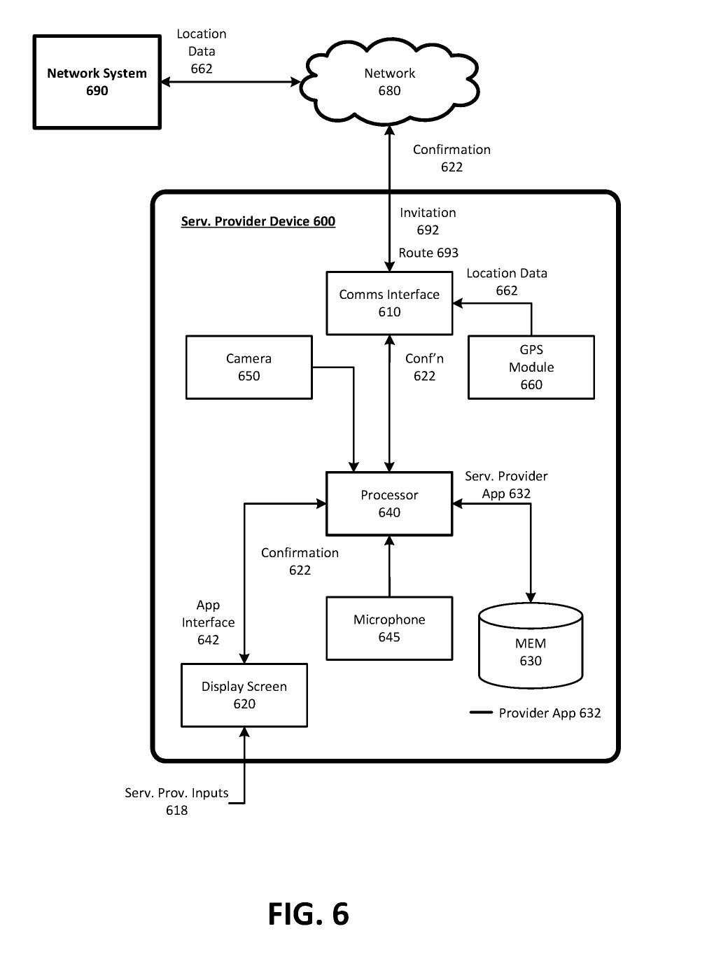

FIG. 6 is a block diagram illustrating an example service provider device executing and operating a designated service provider application for communicating with a network service, according to examples described herein. In many implementations, the service provider device 600 can comprise a mobile computing device, such as a smartphone, tablet computer, laptop computer, VR or AR headset device, and the like. As such, the service provider device 600 can include typical telephony features such as a microphone 645, a camera 650, and a communication interface 610 to communicate with external entities using any number of wireless communication protocols. The service provider device 600 can store a designated application (e.g., a service provider app 632) in a local memory 630. In response to a service provider input 618, the service provider app 632 can be executed by a processor 640, which can cause an app interface 642 to be generated on a display screen 620 of the service provider device 600. The app interface 642 can enable the service provider to, for example, accept or reject invitations 692 in order to service requests throughout a given region.

In various examples, the service provider device 600 can include a GPS module 660, which can provide location data 662 indicating the current location of the service provider to the network system 690 over a network 680. Thus, the network system 690 can utilize the current location 662 of the service provider to determine whether the service provider is optimally located to service a particular request. If the service provider is optimal to service the request, the network system 690 can transmit an invitation 692 to the service provider device 600 over the network 680. The invitation 692 can be displayed on the app interface 642, and can be accepted or declined by the service provider. If the service provider accepts the invitation 692, then the service provider can provide a service provider input 618 on the displayed app interface 642 to provide a confirmation 622 to the network system 690 indicating that the service provider will follow a route 693 received from the network system 690 to fulfill the requested service.

Hardware Diagram

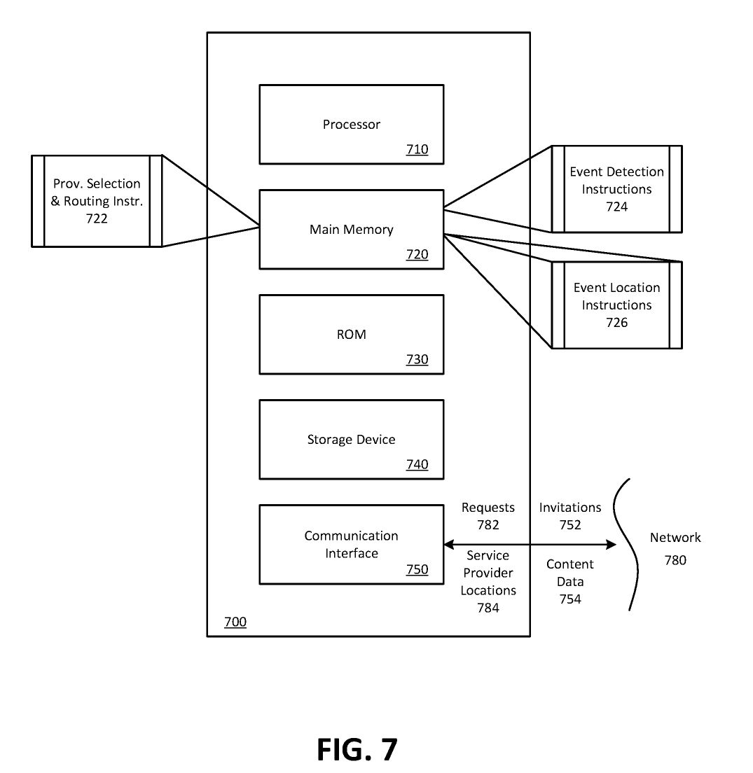

FIG. 7 is a block diagram that illustrates a computer system upon which examples described herein may be implemented. A computer system 700 can be implemented on, for example, a server or combination of servers. For example, the computer system 700 may be implemented as part of a network service, such as described in FIGS. 1 through 6. In the context of FIGS. 1 and 2, the network systems 100 and 200 may be implemented using a computer system 700 such as described by FIG. 7. The network systems 100 and 200 may also be implemented using a combination of multiple computer systems as described in connection with FIG. 7.

In one implementation, the computer system 700 includes processing resources 710, a main memory 720, a read-only memory (ROM) 730, a storage device 740, and a communication interface 750. The computer system 700 includes at least one processor 710 for processing information stored in the main memory 720, such as provided by a random access memory (RAM) or other dynamic storage device, for storing information and instructions which are executable by the processor 710. The main memory 720 also may be used for storing temporary variables or other intermediate information during execution of instructions to be executed by the processor 710. The computer system 700 may also include the ROM 730 or other static storage device for storing static information and instructions for the processor 710. A storage device 740, such as a magnetic disk or optical disk, is provided for storing information and instructions.

The communication interface 750 enables the computer system 700 to communicate with one or more networks 780 (e.g., cellular network) through use of the network link (wireless or wired). Using the network link, the computer system 700 can communicate with one or more computing devices, one or more servers, one or more databases, and/or one or more self-driving vehicles. In accordance with examples, the computer system 700 receives requests 782 from mobile computing devices of individual users. The executable instructions stored in the memory 730 can include provider routing and selection instructions 722, which the processor 710 executes to determine an optimal route and select a service provider to service the request 782.

The executable instructions stored in the memory 720 can also include content generation instructions 724, which enable the computer system 700 to access user profiles 726 and other user information in order to select and/or generate user content 754 for display on the user devices. As described throughout, user content 754 can be generated based on information pertaining to the state of the request (e.g., status information). By way of example, the instructions and data stored in the memory 720 can be executed by the processor 710 to implement an example network system 100 of FIG. 1. In performing the operations, the processor 710 can receive requests 782 and service provider locations 784, and submit invitation messages 752 to facilitate the servicing of the requests 782. The processor 710 is configured with software and/or other logic to perform one or more processes, steps and other functions described with implementations, such as described by FIGS. 1 to 4, and elsewhere in the present application.

Examples described herein are related to the use of the computer system 700 for implementing the techniques described herein. According to one example, those techniques are performed by the computer system 700 in response to the processor 710 executing one or more sequences of one or more instructions contained in the main memory 720. Such instructions may be read into the main memory 720 from another machine-readable medium, such as the storage device 740. Execution of the sequences of instructions contained in the main memory 720 causes the processor 710 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A network system comprising:
one or more processors; and
one or more memory resources storing instructions that, when executed by the one or more processors, cause the one or more processors to:
store, in a database, a record associated with a service for a requesting user and provided by a service provider, the requesting user being associated with a requesting user device and the service provider being associated with a provider device;
associate, with the record, data indicating a start event for the service, including a start time;
during a duration of time subsequent to the start time and before a determination of an end event for the service, receive a first event indication from a first one of the provider device or the requesting user device, the first event indication including audio data captured by a microphone of the first one of the provider device or the requesting user device in an environment of the service provider and the requesting user;
determine whether a safety event has occurred by analyzing the first event indication; and
in response to determining that a safety event has occurred, perform one or more safety operations.

2. The network system of claim 1, wherein the first event indication is generated based on detecting an elevation in pitch or volume of an acoustic signal of the environment.

3. The network system of claim 2, wherein the executed instructions further cause the one or more processors to determine whether a safety event has occurred by comparing the detected elevation in pitch or volume against a normalized value for the environment.

4. The network system of claim 1, wherein the executed instructions further cause the one or more processors to determine whether a safety event has occurred by:
causing a second one of the provider device or the requesting user device to initiate monitoring of the environment of the service provider and the requesting user;
receiving a second event indication generated by the second one of the provider device or the requesting user device, the second event indication including audio data captured by a microphone of the second one of the provider device or the requesting user device in the environment of the service provider and the requesting user; and
analyzing the second event indication.

5. The network system of claim 1, wherein the executed instructions further cause the one or more processors to determine a concerned party based on the received first event indication.

6. The network system of claim 1, wherein the one or more safety operations include transmitting a notification to the provider device or to the requesting user device.

7. The network system of claim 1, wherein the one or more safety operations include transmitting data to the provider device or the requesting user device to initiate audio or video communication with the provider device or the requesting user device.

8. The network system of claim 1, wherein the one or more safety operations include transmitting data to the provider device or the requesting user device to cause the provider device or the requesting user device to capture video and to transmit, to the network system, data corresponding to the captured video.

9. The network system of claim 1, wherein the one or more safety operations include:
identifying, from a location database, a location determined to be safe based on a location of the provider device or the requesting user device;
updating a service route of the service provider, the updated service route including the identified location; and
transmitting data corresponding to an updated route to the provider device.

10. The network system of claim 1, wherein the one or more safety operations include transmitting location data to a third party.

11. The network system of claim 1, wherein the executed instructions further cause the one or more processors to:
receive a second event indication from a second provider device of a second service provider or a second user device of a second user;
analyze the second event indication to determine whether the second event indication corresponds to the safety event; and
in response to determining that the second event indication corresponds to the safety event, determine an approximate location of the safety event.

12. The network system of claim 11, wherein determining an approximate location of the safety event is based on respective times of receipt of the first event indication and the second event indication.

13. The network system of claim 11, wherein determining an approximate location of the safety event is based on the respective locations of the service provider and the second service provider.

14. The network system of claim 11, wherein the one or more safety operations include transmitting data corresponding to the safety event, including data corresponding to the approximate location of the safety event, to computer systems operated by one or more emergency services.

15. A non-transitory computer readable medium storing instructions that, when executed by one or more processors, cause the one or more processors to:
store, in a database, a record associated with a service for a requesting user and provided by a service provider, the requesting user being associated with a requesting user device and the service provider being associated with a provider device;
associate, with the record, data indicating a start event for the service, including a start time;
during a duration of time subsequent to the start time and before a determination of an end event for the service, receive a first event indication from a first one of the provider device or the requesting user device, the first event indication including audio data captured by a microphone of the first one of the provider device or the requesting user device in an environment of the service provider and the requesting user;
determine whether a safety event has occurred by analyzing the first event indication; and
in response to determining that a safety event has occurred, perform one or more safety operations.

16. The non-transitory computer readable medium of claim 15, wherein the one or more safety operations include transmitting a notification to the provider device or to the requesting user device.

17. The non-transitory computer readable medium of claim 15, wherein the executed instructions further cause the one or more processors to:
receive a second event indication from a second provider device of a second service provider or a second user device of a second user;
analyze the second event indication to determine whether the second event indication corresponds to the safety event; and
in response to determining that the second event indication corresponds to the safety event, determine an approximate location of the safety event.

18. A computer-implemented method of determining potential safety events occurring during a provision of a network service by a service provider for a requesting user, comprising:
storing, in a database, a record associated with a service for a requesting user and provided by a service provider, the requesting user being associated with a requesting user device and the service provider being associated with a provider device;
associating, with the record, data indicating a start event for the service, including a start time;
during a duration of time subsequent to the start time and before a determination of an end event for the service, receiving a first event indication from a first one of the provider device or the requesting user device, the first event indication including audio data captured by a microphone of the first one of the provider device or the requesting user device in an environment of the service provider and the requesting user;
determining whether a safety event has occurred by analyzing the first event indication; and
in response to determining that a safety event has occurred, performing one or more safety operations.

19. The method of claim 18, wherein the one or more safety operations include transmitting a notification to the provider device or to the requesting user device.

20. The method of claim 18, further comprising:
receiving a second event indication from a second provider device of a second service provider or a second user device of a second user;
analyzing the second event indication to determine whether the second event indication corresponds to the safety event; and
in response to determining that the second event indication corresponds to the safety event, determining an approximate location of the safety event.
